(19) United States
(12) Patent Application Publication
(10) Pub. No.: US 2006/0161919 A1
(43) Pub. Date: Jul. 20, 2006

(54) Implementation of load linked and store conditional operations

(76) Inventors: Peter Z. Onufryk, Flanders, NJ (US); Allen Stichter, Flemington, NJ (US)

Correspondence Address: CARR & FERRELL LLP, 2200 GENG ROAD, PALO ALTO, CA, 94303, US

(21) Appl. No.: 11/021,894

(22) Filed: Dec. 23, 2004

(51) Int. Cl. G06F 9/46

(52) U.S. Cl. 718/102

(57) ABSTRACT

Systems and methods of managing Load Linked and Store Conditional operations in a multithread processing environment are disclosed. These systems and methods utilize a multithread control data structure to assure the atomicity of multiple read-modify-write sequences executed by concurrent processing threads while avoiding live-lock and without halting a concurrent processing thread to wait for the conclusion of a Store Conditional operation executed by another concurrent processing thread. Three different multithread control data structures and associated methods are disclosed. The multithread control data structure is optionally implemented in hardware.

### BACKGROUND

1. Field of the Invention

The invention is in the field of data processing and more specifically in the field of multithread data processing.

2. Related Art

Standard processor architectures, such as those supported by MIPS, Inc. of Mountain View Calif., include Load Linked (LL) and Store Conditional (SC) instructions for executing atomic read-modify-write sequences. The Load Linked instruction reads the contents of a memory location at the start of an atomic read-modify-write sequence. The contents are typically read into a register where they may then be modified. The Store Conditional instruction is then used to write the contents back to the original memory location and thus complete the atomic read-modify-write sequence. When the atomic read-modify-write sequence is completed successfully a one is returned in the Store Conditional instruction and the contents of the memory location may have been modified. When the atomic read-modify-write sequence is unsuccessful, a zero is returned in the Store Conditional instruction and the memory location is not modified by the read-modify-write sequence. The atomic read-modify-write sequence may be considered unsuccessful if the memory location is modified by some other process between the execution of the Load Linked instruction and the Store Conditional instruction (e.g., the atomicity is broken).

The standard MIPS architecture including Load Linked and Store Conditional instructions has traditionally been used to implement read-modify-write sequences in cache coherent multiprocessor systems. In these implementations, a lock flag is associated with each of the processors. When a Load Linked instruction is executed by one of the processors, contents of the cache are read and the lock flag associated with that processor is set (e.g., a value of one is stored in the lock flag). If an external event invalidates the cache or the processor executes an operation that may invalidate an atomic sequence (e.g., an exception) then the lock flag is cleared (e.g., a value of zero is stored in the lock flag). When a subsequent Store Conditional instruction, associated with the Load Linked instruction, is executed the lock flag is checked. If the flag is still set, then the Store Conditional instruction is deemed successful and the read-modify-write sequence is completed. If the flag is no longer set when checked by the Store Conditional instruction, then the Store Conditional instruction is deemed unsuccessful and returns a zero. In this latter case, the read-modify-write sequences fails and is typically tried again starting with the Load Linked instruction.

An illustrative read-modify-write sequence includes the computing instructions shown in Table 1.

TABLE 1

| | | |
|---|---|---|
| L1: | | # label L1 |
| LL | T1, (T0) | # load memory location T0 into register T1 |
| ADDI | T2, T1, 1 | # add 1 to register T1 and store in register T2 |
| SC | T2, (T0) | # try to store contents of register T2 in memory |
| | | # location T0, register T2 is set to one or zero |
| | | # depending on the success of the SC instruction |
| BEQ | T2, 0, L1 | # compare the contents of T2 with zero, if equal |
| | | # jump to label L1 |

The Load Linked and Store Conditional instructions may also be used in a processor configured to execute multiple software threads wherein the processor does not depend on implementation of a cache coherence protocol. In these systems the lock flag is cleared whenever there is a possibility of switching between processing threads. This avoids having a Store Conditional instruction in a first thread deemed successful because the lock flag was set by a Load Linked instruction executed by a second thread.

A multithread processor differs from a uniprocessor executing multiple software threads in that in the multithread processor thread execution is interleaved by a hardware scheduler rather than a software scheduler executing on the uniprocessor. In a multithread processor clearing the lock flag each time an instruction is executed by another thread creates the possibility that competing threads will interact in a manner in which the progress of each thread is prevented by the other. In this situation, called live-lock, an atomic operation of the first thread fails because of an atomic operation of the second thread. Then, when the first atomic operation is retried, this second attempt by the first thread causes the atomic operation of the second thread to fail. This mutual preemption could continue indefinitely, preventing further execution of either thread. Thus, in multithread processors it is customary to inhibit execution of instructions by other threads between Load Link and associated Store Conditional instructions of a first thread. However, this approach can have a significant negative impact on total processing throughput. There is therefore a need for improved systems and methods of managing Load Linked and associated Store Conditional instructions in multithread processors.

### SUMMARY

The invention is directed to improved systems and methods of performing load Linked and Store Conditional operations atomically in a multithread processing environment. These systems and methods reduce the need to halt the execution of other threads when a first thread executes a Load Linked operation, and thus may significantly improve system throughput.

Various embodiments of the invention include the use of multiple flags to preserve the atomicity of Load Linked and Store Conditional instructions executed in parallel by more than one processing thread. For example, if two processing threads attempt to execute store conditional instructions on the same memory location a first of the operations is allowed to execute atomically while the second may be delayed to preserve the atomicity of the first. At least one of the Store Conditional instructions is allowed to succeed and, therefore, live-lock is avoided.

Various embodiments of the invention include different data structures including multiple flags configured for managing atomicity of operations performed using the load linked and store conditional instructions. These data structures may be embodied in hardware and are used in a variety of methods as disclosed further herein.

Various embodiments of the invention include a system for executing a plurality of concurrent processing threads, the system comprising a plurality of memory locations accessible to the plurality of concurrent processing threads, a data structure embodied in integrated circuitry and including a plurality of status flags, each of the plurality of concurrent processing threads being associated with one of the plurality of status flags, first computing instructions configured for performing a load linked operation on a first of the plurality of memory locations using a first of the plurality of concurrent processing threads, the load linked operation including setting a first of the plurality of status flags, the first status flag being configured to indicate atomicity of an operation being executed by the first concurrent processing thread, and second computing instructions configured for performing a store conditional operation associated with the load linked operation, the store conditional operation including writing a value to the first of the plurality of memory locations if the first status flag is still set, and if the store conditional operation is successful clearing at least one status flag in the plurality of status flags, other elements being optional.

Various embodiments of the invention include a system for executing a plurality of concurrent processing threads, the system comprising a plurality of memory locations accessible to the plurality of concurrent processing threads a data structure including a plurality of data records, each of the plurality of data records being associated with a member of the plurality of concurrent processing threads and including a status flag and an address field configured to store an address of one or more of the plurality of memory locations, first computing instructions configured for performing a load linked operation on a first of the plurality of memory locations using a first of the plurality of concurrent processing threads, the load linked operation including setting the status flag in a first data record of the plurality of data records and storing the address of one or more of the plurality of memory locations in the first data record, and second computing instructions configured for performing a store conditional operation associated with the load linked operation, the store conditional operation including writing a value to the first of the plurality of memory locations if the status flag in the first data record is still set, and if the status flag in the first data record is still set clearing one or more status flags in any of the plurality of data records that include the address of the first of the plurality of memory locations, other elements being optional.

Various embodiments of the invention include a system for executing a plurality of concurrent processing threads, the system comprising a plurality of memory locations accessible to the plurality of concurrent processing threads, a data structure including a plurality of data records, each of the plurality of data records including an address field configured to store an address of one or more of the plurality of memory locations and including a plurality of status flags each associated with one of the plurality of concurrent processing threads, first computing instructions configured for performing a load linked operation on a first of the plurality of memory locations using a first of the plurality of concurrent processing threads, the load linked operation including setting a first status flag of the plurality of status flags in a first data record of the plurality of data records and storing the address of one or more of the plurality of memory locations in the first data record, the first status flag being associated with the first of the plurality of concurrent processing threads, and second computing instructions configured for performing a store conditional operation associated with the load linked operation, the store conditional operation including writing a value to the first of the plurality of memory locations if the first flag of the plurality of flag fields is still set, and if the store conditional operation is successful clearing a status flag in the plurality of flag fields of the first data record, other elements being optional.

Various embodiments of the invention include a method of managing concurrent processing threads, the method comprising, executing a first load linked operation including reading data from a memory location using a first of the concurrent processing threads, and setting a first status flag associated with the first of the concurrent processing threads, and executing a first store conditional operation including checking the first status flag associated with the first of the concurrent processing thread, if the checked first status flag is in a cleared state terminating the store conditional operation unsuccessfully, if the checked first status flag is in a set state clearing a second status flag associated with a second of the concurrent processing threads and writing the data to the memory location to complete the store conditional operation successfully, other steps being optional.

Various embodiments of the invention include a method of managing concurrent processing threads, the method comprising executing a first load linked operation including reading data from a memory location using a first of the concurrent processing threads, storing an address of the memory location in a first record associated with the first concurrent processing thread, and setting a first status flag associated with the first of the concurrent processing threads, and executing a first store conditional operation including checking the first status flag, and if the first status flag is in a cleared state terminating the store conditional operation unsuccessfully, identifying a second record including the address, the second record being associated with a second of the concurrent processing threads, clearing a second status flag associated with the second of the concurrent processing threads, and writing the data to the memory location to complete the store conditional operation successfully, other steps being optional.

Various embodiments of the invention include a method of managing concurrent processing threads, the method comprising executing a first load linked operation including reading data from a memory location using a first of the concurrent processing threads, searching for an address of the memory location in a first data record and setting a first status flag associated with the first of the concurrent processing threads, and executing a first store conditional operation including searching for the first record using the address of the memory location, terminating the store conditional operation unsuccessfully if the first record is not found using the address of the memory location, checking the first status flag, and if the first status flag is in a cleared state terminating the store conditional operation unsuccessfully, clearing a second status flag associated with a second of the concurrent processing threads, the second status flag being included in the first record, and writing the data to the memory location to complete the store conditional operation successfully, other steps being optional.

### BRIEF DESCRIPTION OF THE VARIOUS VIEWS OF THE DRAWING

FIG. 1 includes a block diagram of a multithread processing system, according to various embodiments of the invention;

FIG. 2 includes an illustration of a data structure, according to various embodiments of the invention;

FIG. 3 includes a flowchart illustrating a method of using the data structure illustrated in FIG. 2, according to various embodiments of the invention;

FIG. 4 includes an illustration of an alternative data structure, according to various alternative embodiments of the invention;

FIG. 5 includes a flowchart illustrating a method of using the data structure illustrated in FIG. 4, according to various embodiments of the invention;

FIG. 6 includes an illustration of an alternative data structure, according to various alternative embodiments of the invention; and

FIG. 7 includes a flowchart illustrating a method of using the data structure illustrated in FIG. 6, according to various embodiments of the invention.

### DETAILED DESCRIPTION

Improved systems and methods of multithread processing are achieved through new data structures and methods of using these data structures. Specifically, in various embodiments, Load Linked and Store Conditional instructions are used to perform operations in a multithread processor without the need to halt the execution of concurrent processing threads.

Potential conflicts between concurrent processing threads are managed through the use of a plurality of status flags, typically stored in a multithread control data structure. Three alternative examples of multithread control data structures are described herein to illustrate various embodiments of the invention. In some of the illustrated embodiments, each of the plurality of status flags is associated with a particular processing thread. In some of the illustrated embodiments, each of the plurality of status flags is associated with one or more memory location. In either case, the states of the status flags are used to assure the atomicity of Load Linked and Store Conditional operations performed by the concurrent processing threads using Load Linked and Store Conditional instructions.

For example, in one embodiment the multithread control data structure includes four status flags, each associated with one of four concurrent processing threads. Load Linked and Store Conditional operations performed by a first of the four processing threads are configured to operate dependent on a first of the four status flags. The Load Linked operation is configured to set the first status flag and the Store Conditional operation is configured to fail if the first status flag is no longer set. In contrast with the prior art, the Store Conditional operation is also configured to clear others of the four status flags. Thus, in this embodiment, once a Store Conditional operation succeeds, status flags are changed such that pending read-modify-write sequences will fail. The atomicity of read-modify-write sequences are, therefore, preserved while continuing to execute all the active processing threads. Further details of this and additional embodiments are described herein.

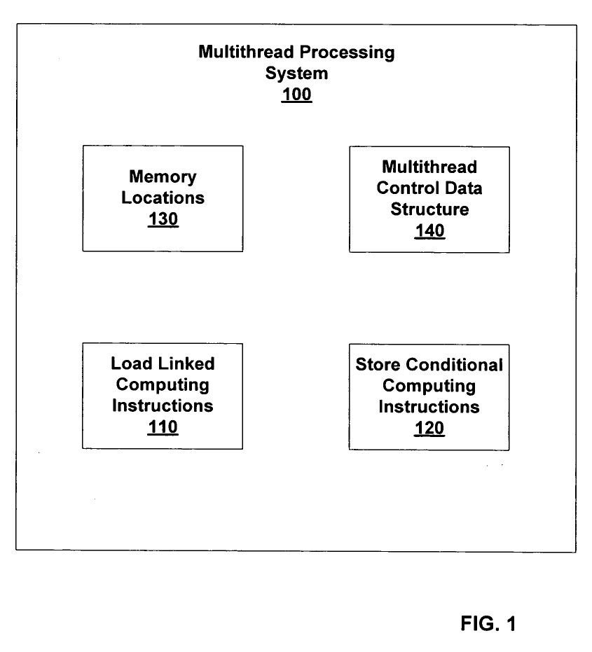

FIG. 1 includes a block diagram of a Multithread Processing System 100, according to various embodiments of the invention. Multithread Processing System 100 includes Load Linked Computing Instructions 110, Store Conditional Computing Instructions 120, Memory Locations 130, and a Multithread Control Data Structure 140. Typically, Multithread Processing System 100 is embodied in an integrated circuit or set of integrated circuits.

Load Linked Computing Instructions 110 include hardwired, firmware, or software computing instructions configured to perform an atomic Load Linked operation on one or more of Memory Locations 130. This Load Linked operation includes setting one or more status flags in Multithread Control Data Structure. For example, in some embodiments. Load Linked Computing Instructions 110 are configured to read the contents of a memory location (of Memory Locations 130) within a data cache into a register of a multithread processing integrated circuit. Load Linked Computing Instructions 110 may be executed by a plurality of concurrent processing threads.

Store Conditional Computing Instructions 120 include hardwired, firmware, or software computing instructions configured to perform an atomic Store Conditional operation associated with the Load Linked operation performed using Load Linked Computing Instructions 110. Load Linked operations and Store Conditional operations that are associated operate on the same memory location and are executed by the same processing thread, typically as part of a read-modify-store sequence.

Store Conditional Computing Instructions 120 are configured to execute responsive to one or more status flags included in Multithread Control Data Structure 140. Store Conditional Computing Instructions 120 are further configured to clear one or more status flags included in Multithread Control Data Structure 140 when performed successfully. For example, in some embodiments, a Store Conditional operation performed using Store Conditional Computing Instructions 120 is configured to fail if a flag previously set by associated Load Linked Computing Instructions 110 is no longer set at the time the Store Conditional Computing Instructions 120 are executed. In these embodiments, if the Store Conditional operation is successful then typically all status flags associated with Load Linked/Store Conditional operations of other processing threads are cleared.

As described further herein the execution of Load Linked Computing Instructions 110 and Store Conditional Computing Instructions 120 utilizes a particular embodiment of Multithread Control Data Structure 140 included in Multithread Processing System 100.

Memory Locations 130 include one or more memory locations and may be embodied in memory external to or within an integrated circuit including Load Linked Computing Instructions 110 or Multithread Control Data Structure 140. For example, in various embodiments Memory Locations 130 are included in random access memory or a storage device. In some embodiments, Memory Locations 130 are included in a cache within an integrated circuit.

Multithread Control Data Structure 140 includes memory configured to store status flags for managing Load Linked and Store Conditional operations. In various embodiments Multithread Control Data Structure 140 further includes memory configured to store memory locations and/or validity flags, as further described herein. In some embodiments, the multithread control data structure is distributed. In some embodiments, Multithread Control Data Structure 140 is hardwired into one or more integrated circuit. In some embodiments, Multithread Control Data Structure is embodied in integrated circuitry as firmware or software.

Three illustrative examples of Multithread Control Data Structure 140 are described in further detail herein. These examples are illustrative and implemented in various embodiments of Multithread Processing System 100.

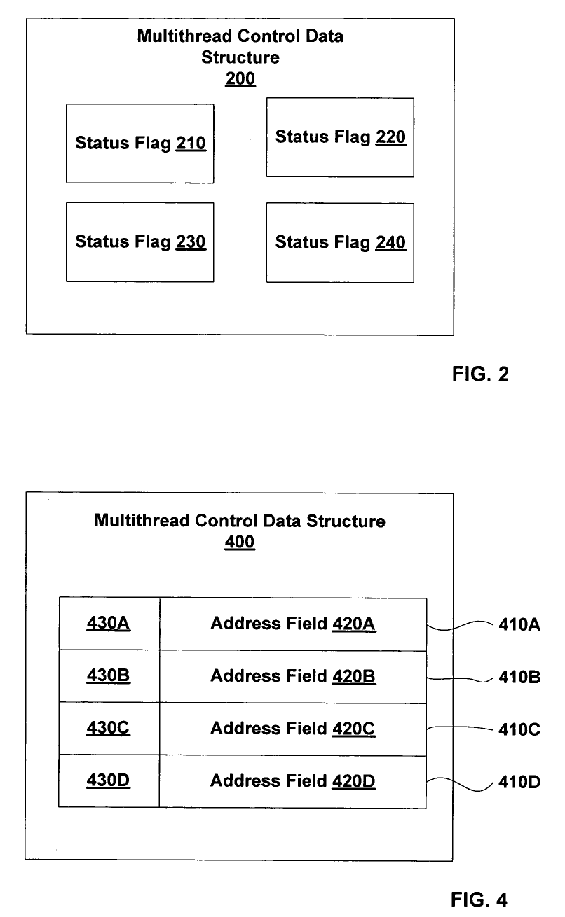

FIG. 2 illustrates a first illustrative embodiment of Multithread Control Data Structure 140. This embodiment is designated Multithread Control Data Structure 200 and includes Status Flag 210, Status Flag 220, Status Flag 230 and Status Flag 240. Each of Status Flags 210-240 is associated with one of four concurrent processing threads that may be executed by Multithread Processing System 100, and is used to manage Load Linked and Store Conditional operations performed by one of these concurrent processing threads. For example, in one embodiment, Status Flag 210 is associated with a first of the concurrent processing threads and Status Flag 220 is associated with a second of the concurrent processing threads. A Load Linked operation performed by the first concurrent processing thread using Load Linked Computing Instructions 110 results in setting of Status Flag 210, while performance of a Load Linked operation by the second concurrent processing thread results in setting of Status Flag 220, etcetera. Each of Status Flags 210-240 are further configured to be cleared by a Store Conditional operation performed by any of the concurrent processing threads using Store Conditional Computing Instructions 120. Thus, in some embodiments, a Store Conditional operation performed by one of the four concurrent processing threads, that may be executing in Multithread Processing System 100, results in clearing of all of Status Flags 210-240.

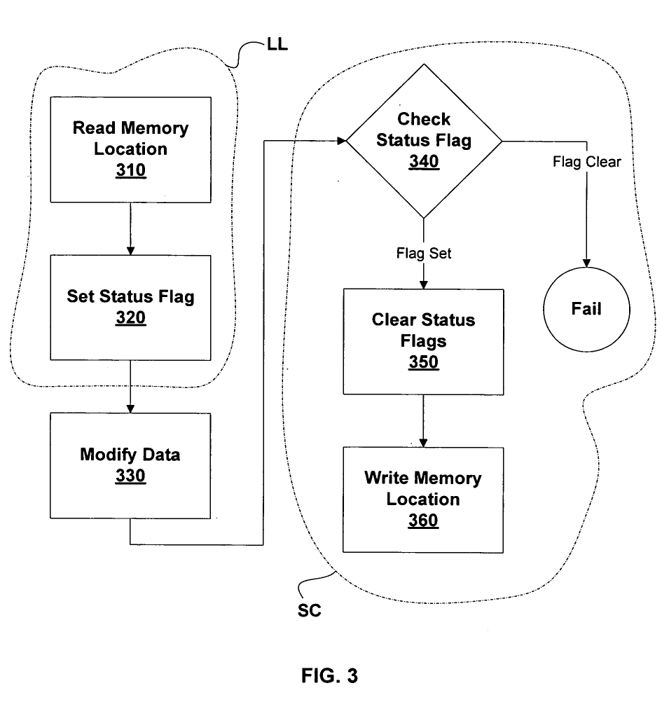

FIG. 3 includes a flowchart illustrating a method of using Multithread Control Data Structure 200, according to various embodiments of the invention. In this method Status Flags 210-240 are used to assure that if more than one concurrent processing threads attempt atomic read-modify-write sequences at the same time, then the read-modify-write sequence that is ready to conclude first is allowed to complete while the other read-modify-write sequence(s) fail. This assures that any read-modify-write sequences that succeed will operate on a memory location that has not been modified by another read-modify-write sequence between the time of the Load Linked and Store Conditional operations of the successful read-modify-write sequence. Atomicity of the successful-read-modify-write sequence is achieved without having to halt concurrent processing threads.

In a Read Memory Location Step 310 Load Linked Computing Instructions 110 are used to read a memory location included in Memory Locations 130. This atomic Load Linked operation includes a Set Status Flag Step 320 and is performed by a first of a plurality of concurrent processing threads executing in Multithread Processing System 100. In Set Status Flag Step 320, Status Flag 210 is set in order to indicate that a subsequent Store Conditional operation by the same thread would be valid. Read Memory Location Step 310 and Set Status Flag Step 320 may correspond to a read component of a read-modify-write sequence.

In an optional Modify Data Step 330, the data read from the memory location is modified. For example, in some embodiments, Read Memory Location Step 310 includes reading a word from a data cache of Multithread Processing System 100 into a register of a multithread processor. In these embodiments Modify Data Step 330 includes applying an addition, comparison, exchange, Boolean, or like operation to the word stored in the register. Modify Data Step 330 may correspond to a modify component of a read-modify-write sequence.

The write component of this read-modify-write sequence is performed by Store Conditional Computing Instructions 120 in an atomic Store Conditional operation that includes a Check Status Flag Step 340, a Clear Status Flags Step 350 and a Write Memory Location Step 360. This Store Conditional operation is associated with the Load Linked operation of Read Memory Location Step 310 and thus operates on the same memory location from which data was read in Read Memory Location Step 310. In Check Status Flag Step 340, Store Conditional Computing Instructions 120 are used to check the state of Status Flag 210. If Status Flag 210 has been cleared then the atomic Store Conditional operation is deemed unsuccessful and typically returns a zero value to the calling processing thread, for example, in order to indicate that the read-modify-write sequence must be retried. Status Flag 210 may have been cleared by a Store Conditional operation executed by a different processing thread or by another event (e.g., an exception) that can destroy the atomicity of processor operations.

If it is determined in Check Status Flag Step 340 that Status Flag 210 is still set, then it is still possible to complete the read-modify-write sequence as an atomic operation. Therefore, in Clear Status Flags Step 350, Status Flags 210-240 are cleared. Clearing these status flags assures that any pending atomic read-modify-write sequences executed by other concurrent processing threads associated with the cleared flags will be terminated unsuccessfully.

In Write Memory Location Step 360, the data read in Read memory Location Step 310 and optionally modified in Modify Data Step 330 is written to the memory location from which data was read from in Read Memory Location Step 310.

FIG. 4 illustrates a second illustrative embodiment of Multithread Control Data Structure 140. This embodiment is designated Multithread Control Data Structure 400 and is configured to take into account the memory location read from during an atomic read-modify-write sequence. By considering this memory location, more than one read-modify-write sequence that overlaps in time but do not operate on the same memory may be allowed to succeed while maintaining atomicity. The number of unsuccessful read-modify-write operations may, therefore, be reduced relative to the systems and methods illustrated by FIGS. 2 and 3.

Multithread Control Data Structure 400 includes four Control Records 410A-410D, each associated with one of four concurrent processing threads that may be executed by Multithread Processing System 100. Each of Control Records 410A-410D are configured to manage Load Linked and Store Conditional operations performed by their associated concurrent processing thread. For example, in one embodiment, Control Record 410A is associated with a first of the concurrent processing threads and Control Record 410B is associated with a second of the concurrent processing threads, etcetera.

Each of Control Records 410A-410D includes an address field and a status flag. For example, Control Record 410A includes Address Field 420A and Status Flag 430A. Similarly, Control Records 410B-410D include Address Fields 420B-420D and Status Flags 430B-430D, respectively. Address Fields 420A-420D are each configured to store an address of a memory location involved in a Load Linked operation and Status Flags 430A-430D are configured to indicate a status of the corresponding read-modify-write sequence.

In embodiments of the invention that include Multithread Control Data Structure 400, an atomic Load Linked operation performed by the first concurrent processing thread using Load Linked Computing Instructions 110 results in setting of Status Flag 430A, while performance of an atomic Load Linked operation by the second concurrent processing thread results in setting of Status Flag 430B, etcetera. In addition to setting one of Status Flags 430A-430D, the Load Linked Computing Instructions 110 are configured to write the address of the memory location read in the Load Linked operation into the associated member of Address Fields 420A-420D. For example, if the Load Linked operation is executed by the first concurrent processing thread, then Status Field 430A is set and the address of the memory location read is stored in Address Field 420A. The addresses stored in Address Fields 420A-420D may be absolute physical addresses, addresses within a larger memory block, relative addresses, and/or the like. For example, in some embodiments an address stored is an address within a data cache of a multithreaded processor integrated circuit. The addresses stored in Address Fields 420A-420D may be sufficient to specify an individual memory unit such as a word, or alternatively only the most significant bits of an address sufficient to specify an individual memory unit. When only the most significant bits are stored, the contents of Address Fields 420A-420D represent ranges of individual memory units.

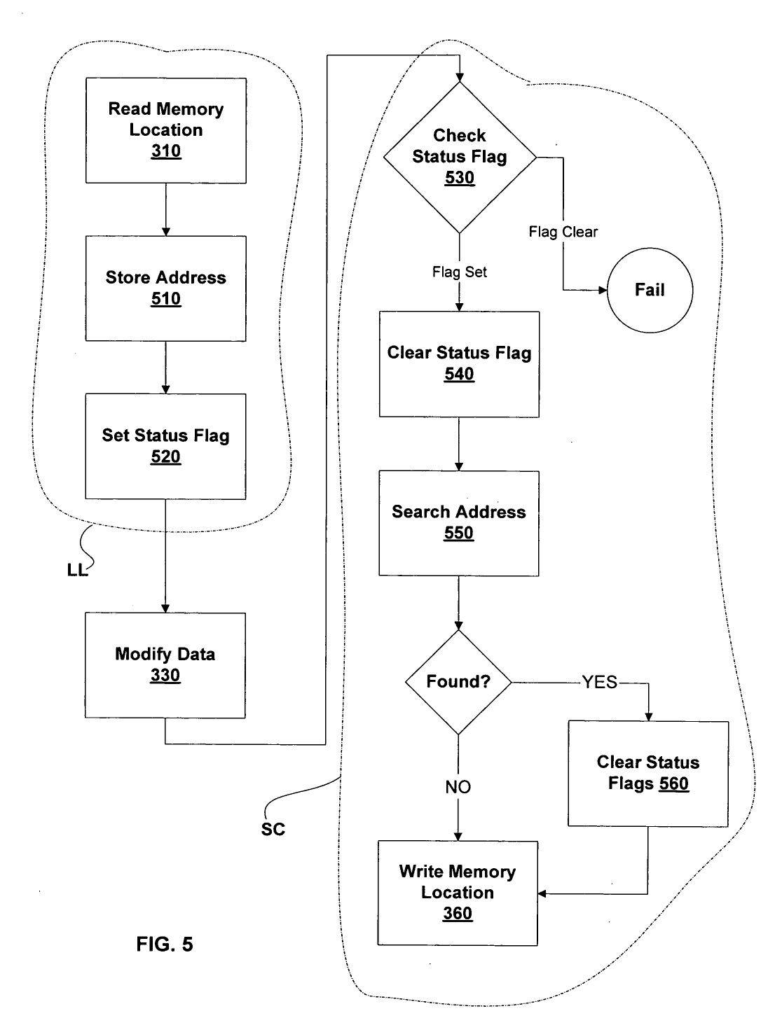

In embodiments of the invention that include Multithread Control Data Structure 400, Store Conditional Computing Instructions 120 are configured to examine the member of Status Flags 430A-430D associated with the current processing thread. For example, if the third processing thread is executing the Store Conditional operation then Status Flag 430C is examined. If Status Flag 430C is still set, then it is cleared, and the remainder of Address Fields 420A-420D are searched for addresses matching the address to which data is to be written. If any are found, then the members of Flags 430A-430D associated with the found member(s) of Address Fields 420A-420D are also cleared. The Store Conditional operation is then allowed to succeed. If Status Flag 430C is no longer set when first examined, then the Store Conditional operation is determined to be unsuccessful and terminated. This failure is typically reported to the concurrent processing thread executing the associated read-modify-write sequence. As is discussed further with reference to FIG. 5, this approach maintains the atomicity of read-modify-write sequences in Multithread Processing System 100 while only terminating those read-modify-write sequences that conflict with another read-modify-write sequence that operates on the same memory.

FIG. 5 includes a flowchart illustrating a method of using Multithread Control Data Structure 400, according to various embodiments of the invention. In this method Control Records 410A-410D are used to assure that if more than one concurrent processing thread attempts atomic read-modify-write sequences at the same time on the same memory, then the read-modify-write sequence that is ready to conclude first is allowed to complete while the other read-modify-write sequence(s) fail. This assures that any read-modify-write sequences that succeed will operate on a memory location that is not modified by another read-modify-write sequence(s) between the atomic Load Linked and atomic Store Conditional operations of the successful read-modify-write sequence. Atomicity of the successful read-modify-write sequence is achieved without having to halt concurrent processing threads and without unnecessarily terminating read-modify-write sequences that overlap in time with the successful read-modify-write sequence but do not modify the same memory.

The method illustrated by FIG. 5 includes a Load Linked operation, which is assumed for the purposes of example to be part of a read-modify-write sequence executed by a first concurrent processing thread associated with Control Record 410A of FIG. 4. Load Linked Computing Instructions 110 are configured to perform this Load Linked operation atomically using Read Memory Location Step 310 (of FIG. 3), a Store Address Step 510, and a Set Status Flag Step 520. In Store Address Step 510, the address from which data is read in Read Memory Location Step 310 is stored in Address Field 420A, and in Set Status Flag Step 520 Status Flag 430A is set. Read Memory Location Step 310, Store Address Step 510 and Set Status Flag Step 520 are typically included in the read component of the read-modify-write sequence.

Following the atomic Load Linked operation, Modify Data Step 330 is optionally used to modify the data read in Read Memory Location Step 310.

The write component of the read-modify-write sequence includes an atomic Store Conditional operation responsive to the address and status flag of Store Address Step 510 and Set Status Flag 520. This Store Conditional operation may include a Check Status Flag Step 530, a Clear Status Flag Step 540, a Search Address Step 550, a Clear Status Flags Step 560 and Write memory Location Step 360 (of FIG. 3).

In Check Status Flag Step 530, Store Conditional Computing Instructions 120 are used to determine the state of Status Flag 430A. If Status Flag 430A has been cleared since Set Status Flag Step 520, then the Store Conditional operation is terminated unsuccessfully and the store-modify-write sequence is typically retried. If Status Flag 430A is still set, then the illustrated method continues to Clear Status Flag Step 540 wherein Status Flag 430A is cleared.

In Search Address Step 550, Control Records 410B-410D are examined to see if any of Address Fields 420B-420D include an address that matches the memory address to be written to in the current Store Conditional operation. If any matches are found then the associated members of Status Flags 430B-430D are cleared in Clear Status Flags Step 560. For example, if Address Field 420D is found to include an address that matches the memory location read in Read Memory Location 310 then Status Flag 430D is cleared. The atomicity of the read-modify-write sequence being performed by the concurrent processing thread associated with Control Record 410D is preserved because the Store Conditional operation included in that sequence will be unsuccessful as a result of Status Flag 430 being cleared. If multiple threads are executing read-modify-write sequences then more than one match may be found in Search Addresses 550 and more than one member of Status Flags 430A-430D may be cleared in Clear Status Flags Step 560.

If successful, the atomic Store Conditional operation is typically concluded with Write Memory Location Step 360.

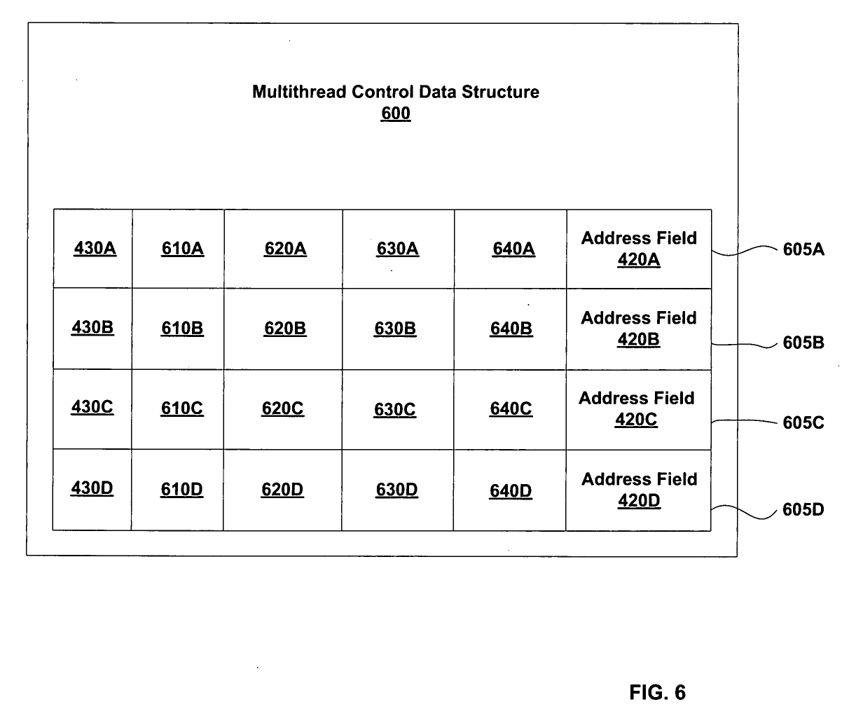

FIG. 6 shows a third illustrative embodiment of Multithread Control Data Structure 140. This embodiment is designated Multithread Control Data Structure 600 and is configured to take into account the memory location read from during an atomic read-modify-write sequence, but does not require a predetermined association between each control record and each concurrent processing thread. Multithread Control Data Structure 500 is optionally used in alternative embodiments wherein each of the concurrent processing threads may be involved in more than one atomic read-modify-write sequence at a time. For example, one of these concurrent processing threads may execute a first Load Linked operation LL₁ followed by a second Load Linked operation LL₂, and then a first Store Conditional operation SC₁ followed by a second Store Conditional operation SC₂. In these alternative embodiments, a single processing thread can perform two overlapping read-modify-write sequences if LL₁ operates on the same memory location as SC₁, and LL₂ and SC₂ operate on a different memory location.

In addition to Address Fields 420A-420D and optional Status Flags 430A-430, Control Records 605A-605D of Multithread Control Data Structure 600 include Status Flags 610A-610D, 620A-620D, 630A-630D, and 640A-640D. Status Flags 610A-610D are associated with the first of four possible concurrent processing threads. Status Flags 620A-620D are associated with the second of the four possible concurrent processing threads. And, Status Flags 630A-630D and 640A-640D are associated with the third and fourth of the four possible concurrent processing threads, respectively. Multithread Control Data Structure 600 includes at least as many Control Records 605A-605D as the number of read-modify-write operations that may occur at one time.

In embodiments of the invention that include Multithread Control Data Structure 600, Load Linked Computing Instructions 110 are configured to store the address of the memory location being read in one of Address Fields 420A-420D, optionally to use Status Flags 430A-430D to indicate which of Control Records 605A-605D are valid and in use, and to set one of Status Flags 610A-610D, 620A-620D, 630A-630D, and 640A-640D to indicate which concurrent processing thread is accessing the memory location stored in the one of Address Fields 420A-420D. For example, if the memory address is stored in Address Field 420B, then Status Flag 610B is set if the first concurrent processing thread is executing the Load Linked operation and Status Flag 620B is set if the second concurrent processing thread is executing the Load Linked operation, etcetera. Optional Status Flag 430B is set if any of Status Flags 610B-640B are set.

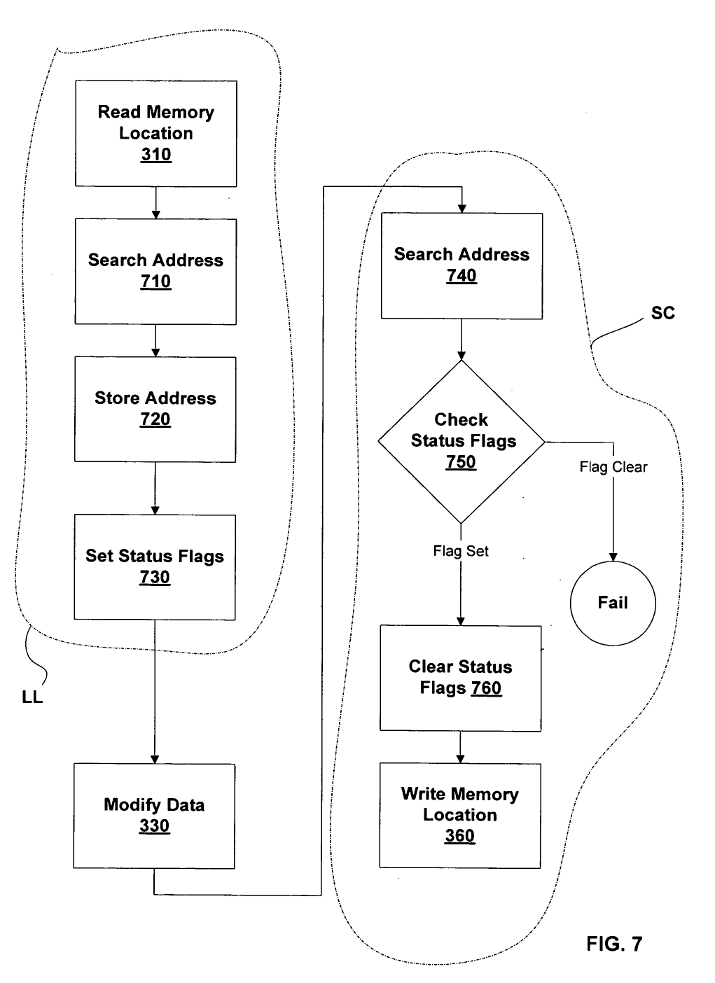

In embodiments of the invention that include Multithread Control Data Structure 600, Store Conditional Computing Instructions 120 are configured to search Address Fields 420A-420D for the memory address to which data is to be written. Once one of Control Records 605A-605D is identified as including the memory address, Store Conditional Computing Instructions 120 are configured to examine Status Flags 610A-610D, 620A-620D, 630A-630D, and 640A-640D (and optionally 430A-430D) to determine if the Store Conditional operation can proceed as part of an atomic read-modify-write operation. Further details of the use of Multithread Control Data Structure 600 are illustrated through FIG. 7.

FIG. 7 includes a flowchart illustrating a method of using Multithread Control Data Structure 600, according to various embodiments of the invention. In this method Control Records 605A-605D are used to assure that if the same memory address is subject to different atomic read-modify-write sequences at the same time, then the read-modify-write sequence that is ready to conclude first is allowed to complete while the other read-modify-write sequence(s) fail. This assures that any read-modify-write sequences that succeed will operate on a memory location that is not modified by one of the other read-modify-write sequence(s) between the time of the Load Linked and Store Conditional operations of the successful read-modify-write sequence, or by an event such as a processor exception. Atomicity of the successful read-modify-write sequence is achieved without having to halt concurrent processing threads and without unnecessarily terminating read-modify-write sequences that overlap in time with the successful read-modify-write sequence but do not modify the same memory. In alternative embodiments, a single member of the concurrent processing threads may execute more than one read-modify-store sequence at a time.

The method illustrated by FIG. 7 includes a Load Linked operation, which is assumed for the purposes of example to be part of a read-modify-write sequence executed by the first concurrent processing thread. Load Linked Computing Instructions 110 are configured to perform this Load Linked operation atomically using Read Memory Location Step 310 (of FIG. 3), a Search Address Step 710, a Store Address Step 720, and a Set Status Flag Steps 730. In Search Address Step 710, Address Fields 420A-420D are examined to see if any contain a match to the address from which data was read in Read Memory Location Step 310.

If no match is found in Search Address Step 710 then the first member of Control Records 605A-605D that is invalid is identified and the address from which data was read is stored in the associated member of Address Fields 420A-420D, in Store Address Step 720. A member of Control Records 605A-605D is invalid (e.g., not in use) if no status flags are set and/or the included member of Status Flag 430A-430D is not set in the control record.

If a match is found in Search Address Step 710, Store Address Step 720 is not required.

In Set Status Flags Step 730, one or more status flag is set in the member of Control Records 605A-605D that includes a match to the address from which data was read. The set status flags include the member of Status Flags 610A-610D that is associated with the concurrent processing thread executing the read-modify-write sequence. For example, if a match is found in Address Field 420C (or Store Address Step 720 was used to store the address in Address Field 420C) then Status Flag 610C is set (assuming the operation is being performed by the first concurrent processing thread). If the operation was being performed by the second concurrent processing thread, then Status Flag 620C would be set instead of Status Flag 610C. Optionally, Status Flag 430C is also set to indicate that this member of Control Records 605A-605C is in use and is valid.

In some embodiments, Set Status Flags Step 730 further includes clearing other status flags such that only one of Status Flags 610A-610D, associated with the first concurrent processing thread, is set. For example, if Status Flag 610C is set in Set Status Flags Step 730, then this instance of Set Status Flags Step 730 may also clear Status Flags 610A, 610B and 610D.

Following the atomic Load Linked operation that includes Read Memory Location Step 310 through Set Status Flags Step 730, Modify Data Step 330 is optionally used to modify the data read in Read Memory Location Step 310.

The write component of a read-modify-write sequence performed using Control Data Structure 600 includes an atomic Store Conditional operation responsive to the addresses and status flags of Multithread Control Data Structure 600. This Store Conditional operation typically includes a Search Address Step 740, a Check Status Flags Step 750, a Clear Status Flags Step 760 and Write Memory Location Step 360 (of FIG. 3).

In Search Address Step 740, Control Records 605A-605D are examined to see if any of Address Fields 420B-420D include an address that matches the memory address to be written to in the current Store Conditional operation. If no matches are found then the current Store Conditional operation is terminated unsuccessfully, and the read-modify-write sequence fails.

If any matches are found in Search Address Step 740, then the associated member of Status Flags 430A-430D are checked in Check Status Flags Step 750. For example, if a matching address is found in Address Field 420B, then the state of Status Flag 430B is checked. If this status flag has been cleared since being set in Set Status Flag Step 720 then the current Store Conditional operation is considered unsuccessful, and the read-modify-write sequence is terminated.

If the check member of Status Flags 430A-430D is still set, then Check Status Flags Step 750 continues by checking the state of a member of Status Flags 610A-610D, 620A-620D, 630A-630D, and 640A-640D that corresponds to the current processing thread. For example, if the matched address was found in Address Field 420D and the third concurrent processing thread (associated with States Flags 630A-630D) is executing the Store Conditional operation, then the state Status Flag 630D is checked. If this status flag has been cleared since being set in Set Status Flag Step 720, then the Store Conditional operation is terminated unsuccessfully and the read-modify-write sequence fails this attempt.

In alternative embodiments, Check Status Flags Step 750 includes checking the state of a member of Status Flags 610A-610D, 620A-620D, 630A-630D, and 640A-640D, and the state of optional Status Flags 430A-430D are ignored.

If the member of Status Flags 610A-610D, 620A-620D, 630A-630D, and 640A-640D checked in Check Status Flags Step 750 is still set, then one or more status flags within the associated member of Control Records 605A-605D are cleared in Clear Status Flags Step 760. For example, if the checked member of Status Flags 610A-610D, 620A-620D, 630A-630D, and 640A-640D was Status Flag 630B then Status Flags 430B, 610B, 620B, 630B and 640B are cleared. Clearing these flags assures that any other read-modify-store sequences operating on the memory location stored in Address Field 420 will be unsuccessful.

If successful, the atomic Store Conditional operation is typically concluded with Write Memory Location Step 360.

The systems and methods illustrated in FIGS. 1-7 assure that live-lock is avoided while allowing multiple read-modify-write sequences to be active at the same time. Only when a Store Conditional operation is successful (or an atomicity destroying external event occurs) are pending read-modify-write sequences terminated unsuccessfully before completion. In the systems and methods illustrated by FIGS. 1, 4-7 only read-modify-write sequences operating on the same memory location(s) are failed when a Store Conditional operation is successful. In typical embodiments, the illustrated systems and methods substantially improve throughput of Multithread Processing System 100.

Several embodiments are specifically illustrated and/or described herein. However, it will be appreciated that modifications and variations are covered by the above teachings and within the scope of the appended claims without departing from the spirit and intended scope thereof. For example, while the illustrated embodiments are described in the context of systems supporting four concurrent processing threads, these examples may be adapted to systems supporting two, three, or more concurrent processing threads. It is also anticipated that in some embodiments Load Linked operations may be associated with multiple Store Conditional operations. (E.g., a LL instruction may be followed by two or more SC instructions each configured to write to the same memory location.) In these embodiments, only the last associated Store Conditional operation may clear a status flag associated with the controlling concurrent processing thread.

It is further anticipated that the atomic read-modify-write sequences described herein may be implemented either internally to a multithread processor and/or externally among several (unithread and/or multithread) processors. For example, in various embodiments Multithread Processing System 100 includes four multithread processors each configured to support four concurrent processing threads. By making all or part of Multithread Control Data Structure 140 accessible to all four multithread processors the sixteen possible concurrent processing threads may execute atomic read-modify-write sequences (e.g., atomic Load Linked and Store Conditional operations) on a shared instance of Memory Locations 130 while avoiding live-lock and without halting other processing threads when one processing thread executes a read-modify-write sequence. In some embodiments Multithread Control Data Structure 140 is distributed among several processors. In these embodiments, a multithread processor may first check the state of status flags associated with internal concurrent processing threads and then check the state of any status flags associated with external concurrent processing threads.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

We claim:

1. A system for executing a plurality of concurrent processing threads, the system comprising:
a plurality of memory locations accessible to the plurality of concurrent processing threads;
a data structure embodied in integrated circuitry and including a plurality of status flags, each of the plurality of concurrent processing threads being associated with one of the plurality of status flags;
first computing instructions configured for performing a load linked operation on a first of the plurality of memory locations using a first of the plurality of concurrent processing threads, the load linked operation including setting a first of the plurality of status flags, the first status flag being configured to indicate atomicity of an operation being executed by the first concurrent processing thread; and
second computing instructions configured for performing a store conditional operation associated with the load linked operation, the store conditional operation including writing a value to the first of the plurality of memory locations if the first status flag is still set, and if the store conditional operation is successful clearing at least one status flag in the plurality of status flags.

2. The system of claim 1, wherein the data structure is implemented in hardware.

3. The system of claim 1, wherein the second computing instructions are configured to clear all status flags in the plurality of status flags.

4. The system of claim 1, wherein the second computing instructions are configured to clear all status flags in the plurality of status flags not associated with the first of the plurality of concurrent processing threads.

5. The system of claim 1, wherein the data structure further includes an address field configured to store an address associated with one or more of the plurality of memory locations.

6. The system of claim 5, wherein the first computing instructions are further configured to store an address of the first of the plurality of memory locations in the address field, and the second computing instructions are further configured to use the address of the first of the plurality of memory locations to determine if the store conditional operation is successful.

7. The system of claim 1, wherein the data structure is accessible to a plurality of processors.

8. The system of claim 1, wherein the data structure is accessible to a plurality of multithread processors.

9. The system of claim 1, wherein the load linked operation and the store conditional operation are included in an atomic read-modify-write sequence.

10. The system of claim 1, wherein the cleared status flag is associated with a second of the concurrent processing threads.

11. The system of claim 1, wherein the first computing instructions and the second computing instructions are embodied in hardware or firmware in an integrated circuit.

12. The system of claim 1, wherein the data structure is accessible to members of the plurality of processing threads executing on different integrated circuits.

13. The system of claim 1, wherein the plurality of processing threads are executed on a plurality of integrated circuits.

14. The system of claim 1, wherein the data structure, the first computing instructions and the second computing instructions are embodied in hardware or firmware in an integrated circuit.

15. A system for executing a plurality of concurrent processing threads, the system comprising:
a plurality of memory locations accessible to the plurality of concurrent processing threads;
a data structure including a plurality of data records, each of the plurality of data records being associated with a member of the plurality of concurrent processing threads and including a status flag and an address field configured to store an address of one or more of the plurality of memory locations;
first computing instructions configured for performing a load linked operation on a first of the plurality of memory locations using a first of the plurality of concurrent processing threads, the load linked operation including setting the status flag in a first data record of the plurality of data records and storing the address of one or more of the plurality of memory locations in the first data record; and
second computing instructions configured for performing a store conditional operation associated with the load linked operation, the store conditional operation including writing a value to the first of the plurality of memory locations if the status flag in the first data record is still set, and if the status flag in the first data record is still set clearing one or more status flags in any of the plurality of data records that include the address of the first of the plurality of memory locations.

16. The system of claim 15, wherein the data structure is implemented in hardware.

17. The system of claim 15, wherein one of the cleared flags is associated with a second of the plurality of concurrent processing threads.

18. The system of claim 15, wherein the data structure is accessible to processing threads executing on a plurality of integrated circuits.

19. The system of claim 15, wherein the data structure is distributed.

20. A system for executing a plurality of concurrent processing threads, the system comprising:
a plurality of memory locations accessible to the plurality of concurrent processing threads;
a data structure including a plurality of data records, each of the plurality of data records including an address field configured to store an address of one or more of the plurality of memory locations and including a plurality of status flags each associated with one of the plurality of concurrent processing threads;
first computing instructions configured for performing a load linked operation on a first of the plurality of memory locations using a first of the plurality of concurrent processing threads, the load linked operation including setting a first status flag of the plurality of status flags in a first data record of the plurality of data records and storing the address of one or more of the plurality of memory locations in the first data record, the first status flag being associated with the first of the plurality of concurrent processing threads; and
second computing instructions configured for performing a store conditional operation associated with the load linked operation, the store conditional operation including writing a value to the first of the plurality of memory locations if the first flag of the plurality of flag fields is still set, and if the store conditional operation is successful clearing a status flag in the plurality of flag fields of the first data record.

21. The system of claim 20, wherein the second computing instructions are configured to clear all of the status flags in the first data record.

22. The system of claim 20, wherein each of the plurality of data records further includes a status field configured to indicate a validity of the data record.

23. The system of claim 20, wherein the first computing instructions and the second computing instructions are configured for the load linked operation and the store conditional operation to be included in an atomic operation.

24. The system of claim 20, wherein the second computing instructions are configured to clear all status flags associated with the first processing thread.

25. The system of claim 20, wherein the load linked operation includes searching the plurality of data records for an address field including the address of the first of the plurality of memory locations.

26. The system of claim 20, wherein the load linked operation includes writing the address of the first of the plurality of memory locations to the first of the plurality of data records.

27. A system for executing a plurality of concurrent processing threads, the system comprising:
means for executing a first load linked operation including
reading data from a memory location using a first of the concurrent processing threads, and
setting a first status flag associated with the first of the concurrent processing threads; and
means for executing a first store conditional operation including checking the first status flag associated with the first of the concurrent processing thread,
if the checked first status flag is in a cleared state terminating the store conditional operation unsuccessfully, and
if the checked first status flag is in a set state clearing a second status flag associated with a second of the concurrent processing threads and writing the data to the memory location to complete the store conditional operation successfully.

28. A system for executing a plurality of concurrent processing threads, the system comprising:
means for executing a first load linked operation including
reading data from a memory location using a first of the concurrent processing threads,
storing an address of the memory location in a first record associated with the first concurrent processing thread, and
setting a first status flag associated with the first of the concurrent processing threads; and
means for executing a first store conditional operation including
checking the first status flag, and if the first status flag is in a cleared state terminating the store conditional operation unsuccessfully,
identifying a second record including the address, the second record being associated with a second of the concurrent processing threads,
clearing a second status flag associated with the second of the concurrent processing threads, and
writing the data to the memory location to complete the store conditional operation successfully.

29. A system for executing a plurality of concurrent processing threads, the system comprising:
means for executing a first load linked operation including
reading data from a memory location using a first of the concurrent processing threads,
searching for an address of the memory location in a first data record, and setting a first status flag associated with the first of the concurrent processing threads; and
means for executing a first store conditional operation including
searching for the first record using the address of the memory location,
terminating the store conditional operation unsuccessfully if the first record is not found using the address of the memory location,
checking the first status flag, and if the first status flag is in a cleared state terminating the store conditional operation unsuccessfully,
clearing a second status flag associated with a second of the concurrent processing threads, the second status flag being included in the first record, and
writing the data to the memory location to complete the store conditional operation successfully.
